(19) United States
(12) Patent Application Publication
(10) Pub. No.: US 2012/0153030 A1
(43) Pub. Date: Jun. 21, 2012

(54) Universal Loyalty or Rewards Program Card

(76) Inventor: Eric D. Hoppe, (US)

(21) Appl. No.: 12/974,242

(22) Filed: Dec. 21, 2010

(51) Int. Cl. G06K 19/06

(52) U.S. Cl. 235/493; 235/494

(57) ABSTRACT

A single rewards card that can be carried by consumers in lieu of multiple rewards cards now in use which reduces the waste of natural resources which occurs when a plethora of cards are produced by each separate merchant or retailer as is currently done. The merchant or retailer pays a small fee to the producer of this universal rewards card in order to participate in the program. By paying this small fee to the producer of the card, the merchant saves money because he does not have to bear the full cost of manufacturing or distributing the card himself, and since multiple merchants will be able to accept or use this one universal card, there is less waste of our natural resources. Finally, the consumer also benefits from this card because they are relieved of the burden of having to carry a large number of rewards cards with them.

### CROSS REFERENCES

U.S. Patent Documents:

U.S. Pat. No. 7,828,206 Hessburg, et al. Nov. 9, 2010

U.S. Pat. No. 7,813,955 Ariff, et al. Oct. 12, 2010

U.S. Pat. No. 7,805,378 Berardi, et al. Sep. 28, 2010

### FIELD

The subject invention is in the field of loyalty, incentive, or rewards cards typically used by merchants or retailers such as grocery stores, drug stores, casinos, hotels, airlines, etc.

### SUMMARY OF THE INVENTION

The current type of rewards cards presently in use are expensive to produce, extremely burdensome for consumers to use, and constitute a gross waste of natural resources. They are expensive to produce and wasteful of natural resources because each merchant produces it's own separate rewards card, which in turn is burdensome on the consumer because it requires the customer to carry a new and separate card for each separate rewards program that the customer wishes to participate in. A single and UNIVERSAL loyalty or rewards card to one embodiment of the present invention provides a single card manufactured by a single supplier which can be registered and used by the consumer at a plurality of merchants or retail outlets. This one single universal rewards card can then be used by the consumer to be enrolled in a plurality of rewards or loyalty programs in use at multiple merchants or retailers.

### DETAILED DESCRIPTION

The subject invention is a single rewards card which can be used universally at a plurality of merchants or retailers that wish to provide a rewards program to their customers. The single or universal rewards card incorporates a unique serial number via UPC type bar code and/or magnetic strip which can be scanned into and stored in the merchants system to enable the merchant to track the customer's (cardholder's) purchases for purposes of implementing a rewards program for said customer. The card will contain a unique (possibly 16 digit) serial number which is issued only to one specific consumer. This unique serial number can then be registered at any retail store or outlet for the enrollment by that customer in the merchant's rewards program. Because the consumer can use this single card at multiple merchants, it alleviates the need for multiple cards to be manufactured and distributed by each merchant, and also alleviates the burden from the consumer of having to carry multiple rewards cards with them everywhere they go.

1. A single and universal rewards program card which can be used by the customer at multiple merchants who wish to provide their customers with a rewards program.

2. The card of claim one which contains a unique serial number via UPC, Bar Code, and/or Magnetic Strip which can be read and registered by merchants for the purposes of tracking a customer's purchasing activities in order to administer rewards to said customer.

3. The card of claim one where the producer of said card charges retailers or merchants a fee to produce and distribute the card to customers or consumers. Said card can be used at a plurality of merchants or retailers who participate in the universal rewards program and who wish to provide their customers with a loyalty rewards program.
